(19) United States
(12) Patent Application Publication
(10) Pub. No.: US 2026/0251772 A1
(43) Pub. Date: Aug. 27, 2026

(54) RANGING DEVICE

(71) Applicant: Infineon Technologies AG, Neubiberg (DE)

(72) Inventors: Leo Happ Botler, Graz (AT); David Barras, Sierre (CH); Boris Dimitrov Danev, Thalwil (CH); Bernhard Wedl, Graz (AT)

(21) Appl. No.: 19/546,657

(22) Filed: Feb. 23, 2026

(30) Foreign Application Priority Data
Feb. 24, 2025 (DE) 102025106927.1

(51) Int. Cl. G01S 13/48; G01S 7/282; G01S 7/292; G01S 7/32; G01S 13/00; G01S 13/46

(52) U.S. Cl. CPC G01S 13/48; G01S 7/282; G01S 7/2925; G01S 7/32; G01S 13/003; G01S 2013/462

(57) ABSTRACT

A ranging device includes a receiver configured to receive first pulses of a sequence of first pulses sent by a transmitter with a first interval between pulses and receive second pulses of a sequence of pulses second sent by the transmitter with a second interval between pulses, wherein the first interval is different from the second interval, and a processor configured to generate a first processing result by analyzing a timing of one or more peaks in a first receive signal received by the receiver in the reception of the first pulses, generate a second processing result by analyzing a timing of one or more peaks in a second receive signal received by the receiver in the reception of the second pulses; and determine a range between the transmitter and the ranging device depending on a result of a comparison of the first processing result and the second processing result.

### TECHNICAL FIELD

The present disclosure relates to ranging devices.

### BACKGROUND

Current UWB (ultra-wide band) ranging technology relies on the transmission of a sequence of pulses. These pulses are typically exchanged between devices to enable accurate ranging. Due to environmental reflections and the limited time interval between pulses, it is possible that reflected pulses (corresponding a given transmission slot) interfere in the next transmission slot(s) in the respective receiving (RX) device causing misleading distance estimations. In particular, this error can occur whenever sufficiently strong reflected pulses fall within a defined back-search window (BSW, time interval at which UWB transceivers search for an earlier peak preceding the stronger peak in the accumulator).

Accordingly, approaches to avoid distance estimation errors in environments where there is strong reflection of UWB radar pulses are desirable.

### SUMMARY

According to various embodiments, a ranging device is provided comprising a receiver configured to receive first pulses of a sequence of first pulses sent by a transmitter with a first interval between pulses and receive second pulses of a sequence of second pulses of sent by the transmitter with a second interval between pulses, wherein the first interval is different from the second interval, and a processor configured to generate a first processing result by analyzing a timing of one or more peaks in a first receive signal received by the receiver in the reception of the first pulses, generate a second processing result by analyzing a timing of one or more peaks in a second receive signal received by the receiver in the reception of the second pulses; and determine a range between the transmitter and the ranging device depending on a result of a comparison of the first processing result and the second processing result.

### BRIEF DESCRIPTION OF DRAWINGS

In the drawings, similar reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a UWB (ultra-wide band) radar system.

FIG. 2 shows signal diagrams illustrating the relation of transmitted pulses and receive signal peaks for two different PRFs (pulse-repetition frequencies) in a first scenario.

FIG. 3 shows signal diagrams illustrating the relation of transmitted pulses and receive signal peaks for two different PRFs in a second scenario.

FIG. 4 shows signal diagrams illustrating the relation of transmitted pulses and receive signal peaks for two different PRFs in a third scenario.

FIG. 5 shows a flow diagram illustrating performing ranging using two PRFs.

FIG. 6 shows two diagrams illustrating received signals.

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

### DETAILED DESCRIPTION

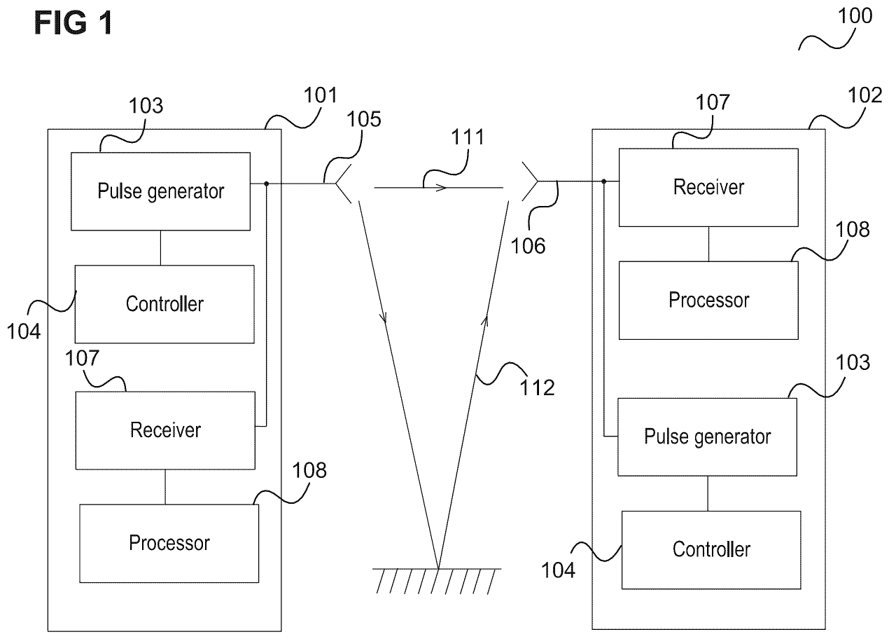

FIG. 1 shows a UWB (ultra-wide band) radar system 100.

The UWB radar system 100 comprises a first UWB 101 and a second UWB device 102.

The first UWB device 101 includes a pulse generator 103, a controller 104, a receiver 107 and a processor 108. The pulse generator 103 generates pulses under the control of the controller 104, in particular with a time interval between subsequent pulses set by the controller 104, i.e. it generates a pulse for each transmission time slot of a sequence of transmission time slots spaced apart by a predetermined time interval. The time interval, which is also referred to as pulse period, corresponds to a pulse-repetition frequency (PRF), i.e. the reciprocal of the PRF is the time interval between subsequent pulses, e.g. time interval=256 ns, PRF≈4 MHz.

A (UWB) transmit antenna 105 of the first UWB device 101 radiates the pulse signals generated by the pulse generator 103.

The second UWB device 102 includes a (UWB) receive antenna 106, a receiver 107 (e.g. comprising an amplifier, a filter and a pulse accumulator) and a processor 108. It further comprises a pulse generator 103 and a controller 104. The processor 108 of the second UWB device 102 analyzes signals received by the receiver 107 via the receive antenna 106.

The receiver 107 may receive pulses radiated by the UWB transmitting device 101 on a direct path 111 (“first path”) to the second UWB device 102 (leading to a “first path” peak in the receiver 107) as well as on a second path 112 with pulses radiated by the first UWB device 101 which are reflected in the environment at surrounding objects and then reach the second UWB device 102 as reflected pulses.

One method of time of flight calculation is the Two Way Ranging. A first anchor transmits a data frame, a second device receives the data frame and waits for a fixed amount of time T. Then, the second device transmits an acknowledgment frame. The first device receives the acknowledgment frame and estimates the delay t accumulated since the transmission of the initial data frame. The fixed amount of time is subtracted and the result is the time of flight, which is a measure for the distance r between the first UWB device 101 and the second UWB device 102: r=½·c·(t−T).

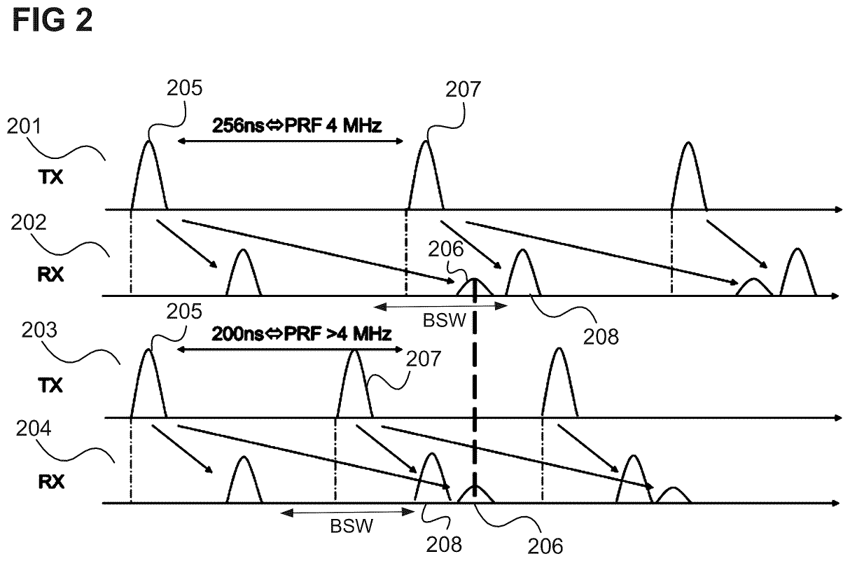

The acknowledgment frame may be transmitted over the first path 111 and/or over a further, reflected path 113. Strong reflections may lead to errors in the ranging, i.e. the estimation between the first UWB device 101 and the second UWB device 102 performed by the processor 108 as illustrated in FIG. 2. Likewise, the acknowledgment signal may be transmitted over the first path and/or another path 113. If the signal received over the path 113 is taken to calculate the time of flight, the measures distance is significantly higher than the actual distance between the devices.

FIG. 2 shows signal diagrams 201-204 illustrating the relation of transmitted pulses (diagrams 201, 203) and receive signal peaks (diagrams 202, 204) for two different sets of repeated pulses (first set: diagrams 201, 202; second set: diagrams 203, 204).

In FIG. 2, as well as the other similar diagrams described further below, the time scale is supposed to be the same for all diagrams, time passes from left to right.

In case of the first set of repeated pulses, the pulse period is 256 ns, see the first diagram 201 and the second diagram 202. The first transmitted pulse 205 is received first directly by the receiver shortly after because the signal of this peak was transmitted along a direct path. However, due to a strong reflection, a second peak 206 is received by the receiver later and with a lower amplitude than the first received peak. When a large peak is received, the smaller signals shortly before large peak are investigated to find the first indication of a UWB signal. The time frame, in which the signal is searched for, is called back search window (BSW).

In this case of signal 201 depicted in FIG. 2, the pulse 206 of a first transmitted pulse 205 shows up in the back search window (BSW) of a second transmitted pulse 207. The corresponding highest receive signal peak 208 indicates the end of the back search window, in which the reflection 206 is received by the receiver 107 shortly before the peak 208. Since the reflection 206 is strong, the processor 108 may wrongly regard the reflection 206 as the first-path peak of the second transmitted pulse 207 and wrongly estimate the distance between the first UWB device 101 and the second UWB device 102.

Therefore, according to various embodiments, the first UWB device 101 (in particular the controller 104) varies the PRF parameter to shift the reflected pulse(s) to different times with respect to the signals received by the respective receiving device, in this case the second UWB device 102.

In the example of FIG. 2, a second PRF has a pulse period of 200 ns, i.e. the second PRF is higher than the first PRF, see the bottom diagram 204. The reflection 206 of the first transmitted pulse 205 is shifted behind the highest receive signal peak 208. Thus, it can no longer be regarded as the first-path peak within the back-search-window. A wrong range estimate for the distance between the first UWB device 101 and the second UWB device 102 by the processor 108 can be avoided since the reflection 206 does not interfere with the range estimation. As illustrated in FIG. 2, the same may be achieved for a reflection of the second transmitted pulse 207.

Accordingly, according to various embodiments, diverse PRFs are used to detect and possibly correct ranging measurements that are disturbed by reflected pulses falling within the back search windows of subsequent slots, also denoted as “aliased” pulses, like the reflection 206 in the example of FIG. 2 for the first PRF.

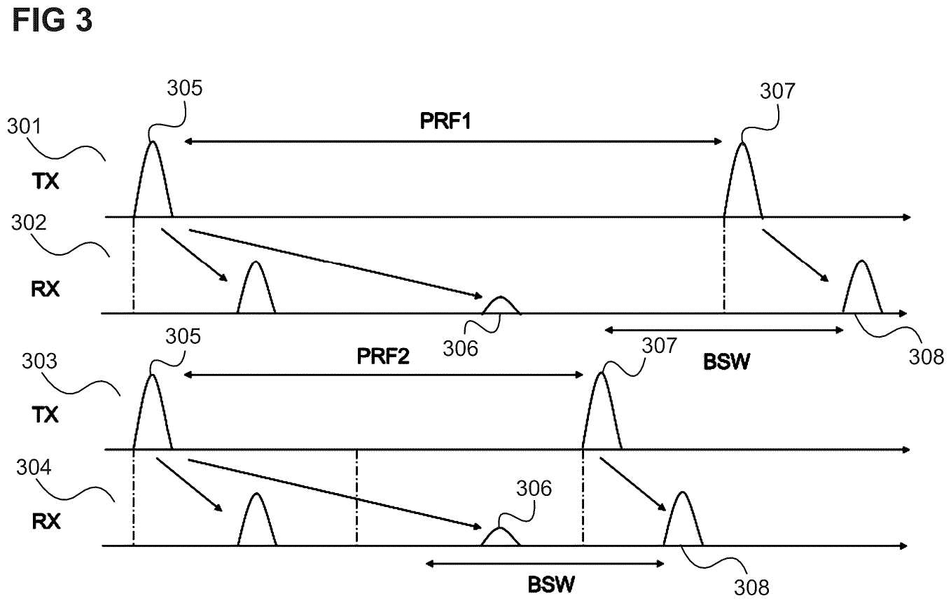

While in the example of FIG. 2, a reflection falls in a back-search window (BSW) for the lower PRF but not for the higher PRF, it is also possible that, for a given lower PRF 1, the reflected pulse appears before the BSW, while for a higher PRF2 it appears within the BSW, as illustrated in FIG. 3.

FIG. 3 shows signal diagrams 301-304 illustrating the relation of transmitted pulses (diagrams 301, 303) and receive signal peaks (diagrams 302, 304) for two different PRFs. The first PRF is illustrated in diagrams 301, 302, while a second PRF governs the diagrams 303, 304.

In case of the first PRF, see the first diagram 301 and the second diagram 302, the reception of a strong reflection (and thus a peak caused by it) 306 of a first transmitted pulse 305 appears before the the back-search window (BSW) for a second transmitted pulse 307. Accordingly, it does not affect the ranging based on pulses transmitted with the first PRF.

However, in the case of the second PRF, see the third and fourth diagrams 303 and 304, the reflection 306 of the first transmitted pulse 305 appears in the back search window for the second transmitted pulse 307, which has a corresponding highest receive signal peak 308. Since the reflection 306 is strong, the processor 108 may wrongly regard the reflection 306 as the first-path peak of the second transmitted pulse 307 and wrongly estimate the distance between the first UWB device 101 and the second UWB device 102. So, the range estimation based on pulses transmitted with the second PRF may be affected by the reflection.

In both scenarios of FIGS. 2 and 3, since the measurement is only affected for one of the PRFs, ranging errors can be detected by comparing ranging results determined for the two PRFs. The correct one of the two may for example be selected based on historical estimates, e.g. if the distance was measured as around 3 m for the last 10 estimates and for one of the PRFs, it is now 20 m while it is still around 3 m for the other PRF, the 3 m estimate can be assumed to be the correct one because such a high change is unlikely. For this approach, a threshold for whether a change is unlikely or not may for example be set based on an expected movement speed of the UWB devices 101, 102.

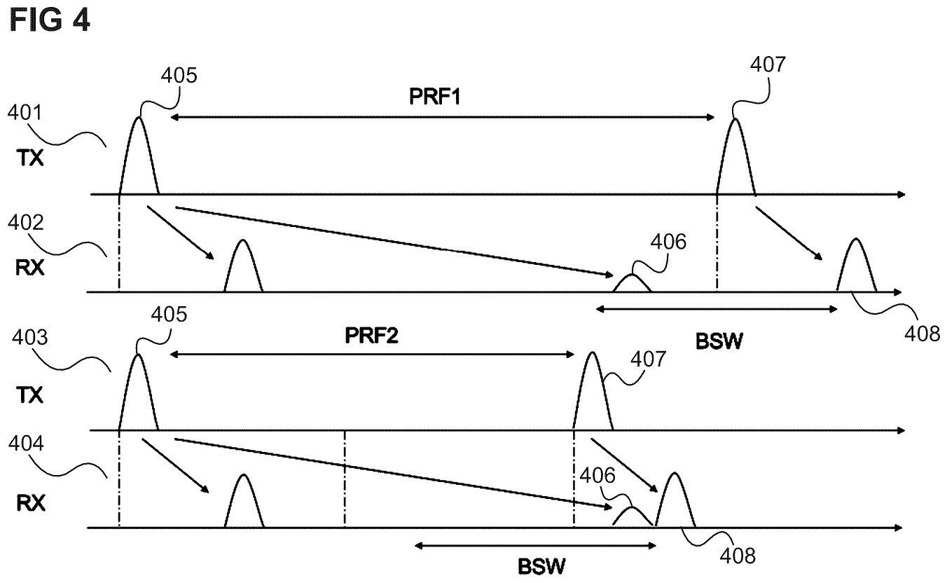

However, it may in fact occur that the range estimates are wrong for both PRFs, as is illustrated in FIG. 4.

FIG. 4 shows signal diagrams 401-404 illustrating the relation of transmitted pulses (diagrams 401, 403) and receive signal peaks (diagrams 402, 404) for two different PRFs (first PRF: diagrams 401, 402; second PRF: diagrams 403, 404).

In case of the first PRF (PRF1), see the second diagram 402, the reception of a strong reflection (and thus a peak caused by it) 406 of a first transmitted pulse 405 is received within the back search window for a second transmitted pulse 407, which has a corresponding highest receive signal peak 408. The reflection 406 is received by the receiver 107 shortly before this peak. Since the reflection 406 is strong, the processor 108 may wrongly regard the reflection 406 as the first-path peak of the second transmitted pulse 407 and wrongly estimate the distance between the first UWB device 101 and the second UWB device 102.

In case of the second PRF (PRF2), which is shorter than PRF1, see the third and fourth diagrams 403 and 404, the reflection 406 of the first transmitted pulse 405 is shifted to the right with respect to the peak 408, but still is still in the back search window for the second transmitted pulse 407. So, again, since the reflection 406 is strong, the processor 108 may wrongly regard the reflection 406 as the first-path peak of the second transmitted pulse 407 and wrongly estimate the distance between the first UWB device 101 and the second UWB device 102.

Accordingly, in such a scenario, both range estimates may be wrong. However, the processor 108 may still detect this by comparing the two range estimates because they will most likely differ. Further, the processor 108 can distinguish the misleading reflected pulse 106 from a legitimate attenuated first-path (FP) peak—for instance—by measuring the distance on the timescale between the strongest peak 408 and the preceding peak, which is the reflected pulse 406 in the example of FIG. 4 but which might also be the FP peak: a legitimate attenuated FP is expected to have the same distance, on the timescale, from the strongest peak 408 while a reflected peak 406 has different distances, as it is the case in FIG. 4, because the difference should not depend on the PRF.

One approach for the processor 108 to detect scenarios as illustrated in FIGS. 2 to 4 is to compare range estimates performed based on pulses transmitted with different PRFs and discard both of them in case they do not match. Discarding range estimates, or other processing results, may be understood as determining the range and determining a final range estimate) without those range estimates (i.e. those that are discarded), i.e. independently from the range estimates that are discarded or omitting the range estimates (or other processing results) that are discarded from the further processing.

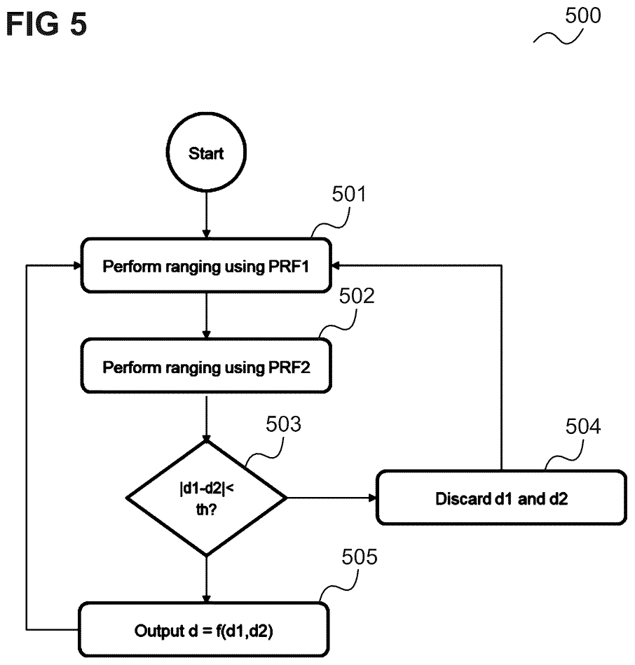

In other words, alternating PRFs (two or more) are used for successive measurements in order to verify if the measurements obtained for the different PRFs match, and filter out results that do not match, whereby small differences, lower than a predetermined threshold, will accepted to ensure a given accuracy. This approach is illustrated in FIG. 5.

FIG. 5 shows a flow diagram 500 illustrating performing ranging using two distinct PRFs, PRF1 and PRF2.

In step 501, the processor 108 of the second UWB device 102 determines a first range estimate d1 for the range between the second UWB device 102 and the first UWB device 101. This estimate is based on the reception of pulses sent by the first UWB device 101 with the first PRF (PRF1).

In step 502, the processor 108 of the second UWB device 102 determines a second range estimate d2 (of the range between the second UWB device 102 and the first UWB device 101) based on the reception of pulses sent by the first UWB device 101 with the second PRF (PRF2).

In step 503, the processor 108 determines whether the difference between the two range estimates is below a predetermined threshold (e.g. several percent, e.g. 5%, e.g. depending on the accuracy that can be usually expected). If the difference is not below the threshold, the processor 108 discards the estimates in 504 and waits for new signals from the receiver 107 to perform ranging again.

If the difference is below the threshold, the processor 108 uses the estimates in 505 to generate a range estimate (e.g. uses both of them or average them to generate a final estimate). It may then wait for new signals from the receiver 107 to perform ranging again.

In another embodiment, the processor 108 can proceed as described with reference to FIG. 5 and upon detecting a significant discrepancy in nearby measurements (i.e. the difference is not below the threshold 503), check for an PRF (e.g. for each of both PRFs)—e.g., via Channel Impulse Responses (CIRs)—whether there is a pulse within the BSW, and discard the measurement obtained for the given PRF if that is the case. In this way, the processor 108 can not only detect but also correct the ranging error, assuming a scenario as in FIG. 2 or 3, where at least for one of the PRFs, the reflection 206, 306 is after the peak 208, 308 such that one of the estimates is correct.

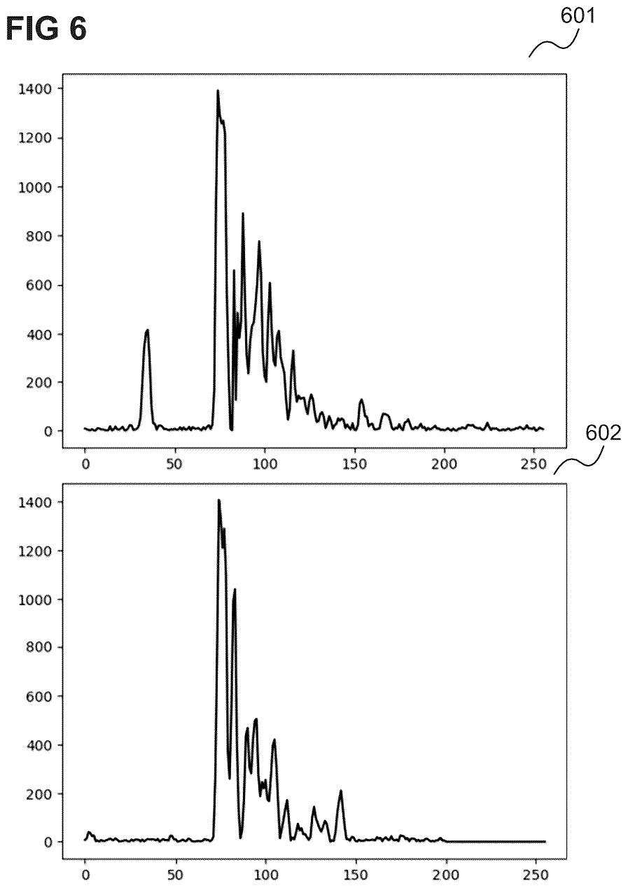

FIG. 6 shows two diagrams 601, 602 illustrating a scenario in which the processor 108 can safely discard the measurement obtained at pulse period 256 ns (upper diagram 601), as the reflected peak has been shifted after the BSW at pulse period 200 ns (bottom diagram 602).

In one embodiment, a significantly lower PRF (e.g., 2 or 4 times lower) can be used if there is a doubt regarding a particular distance estimation. For example, in case the second UWB device 102 determines a range estimate for a first PRF that is suspicious, because it differs more than is reasonable from a preceding range estimate. The second UWB device 102 instructs the first UWB device 101 (e.g. by a corresponding control message) to switch to a second PRF which is significantly lower than the first PRF, i.e. to transmit pulses at the second PRF. While using a low PRF may not be desirable, this is only done in case of estimation errors and thus this approach is more efficient than an approach of constantly using low PRFs to avoid errors.

According to one embodiment, the first UWB device 101 transmits pulses at a single PRF and—upon detection of a suspicious distance measurement by a higher-level application (e.g., filter or another component which detects that a distance estimate differs more than is reasonable from a preceding range estimate)—uses (upon notification or instruction from the second UWB device 102) a different PRF to allow the second UWB device 102 to detect if the error is due to a reflection and take an action, such as discarding the measurement or correcting it, as explained above.

It is also possible that first UWB device 101, if it (or the second UWB device 102) is aware that reflections may be expected, uses a pre-defined PRF or set of PRFs to avoid letting reflected peak(s) fall within the BSW.

In summary, according to various embodiments, a ranging (or radar) device is provided (e.g. corresponding to the second UWB device 102 of the radar system 100 of FIG. 1, which comprises a receiver configured to receive first pulses of a sequence of first pulses sent by a transmitter with a first interval between pulses and receive second pulses of a sequence of pulses second sent by the transmitter with a second interval between pulses. According to one embodiment, the transmitter sends the sequences one after the other but e.g. shortly one after the other such that the distance of the ranging device to the transmitter can be expected to be almost the same.

The first pulses of the sequence of first pulses are, in other words, pulses transmitted at a given pulse repetition frequency (PRF) (sequentially received at the receiver) and the second pluses of the sequence of second pulses are pulses transmitted at a different PRF (also sequentially received at the receiver, e.g. after the first pulses).

The transmission and reception of pulses may be a transmission and reception of packets, wherein each packet comprises multiple pulses.

The first interval is different from the second interval, e.g. by several percent, e.g. by at least 5%, 10% or 15%.

The ranging device further comprises a (processor configured to generate a first processing result by analyzing a timing of one or more peaks in a signal received by the receiver in the reception of the first pulses and a second processing result by analyzing a timing of one or more peaks in a signal received by the receiver in the reception of the second pulses. The processing results may be range estimates and/or distances between earliest peaks and highest peaks in the received signals as explained with reference to FIG. 4.

The processor is configured to determine a range (i.e. the geographical distance) between the transmitter and the ranging device depending on a result of a comparison of the first processing result and the second processing result.

According to various embodiments, in other words different PRFs (or pulse periods) are used to achieve diversity in UWB radar ranging.

Various Examples are described in the following:

Example 1 is a ranging device, comprising a receiver configured to receive first pulses of a sequence of first pulses sent by a transmitter with a first interval between pulses and receive second pulses of a sequence of pulses second sent by the transmitter with a second interval between pulses, wherein the first interval is different from the second interval; and a processor configured to generate a first processing result by analyzing a timing of one or more peaks in a first receive signal received by the receiver in the reception of the first pulses, generate a second processing result by analyzing a timing of one or more peaks in a second receive signal received by the receiver in the reception of the second pulses and determine a range between the transmitter and the ranging device depending on a result of a comparison of the first processing result and the second processing result.

Example 2 is the ranging device of example 1, wherein the processor is configured to perform the comparison of the first processing result and the second processing result by comparing a difference of the first processing result and the second processing result with a threshold.

Example 3 is the ranging device of example 2, wherein the processor is configured to discard the first processing result and/or the second processing result in reaction to the difference of the first processing result and the second processing result exceeding the threshold.

Example 4 is the ranging device of example 3, wherein the processor is configured to, in reaction to the difference of the first processing result and the second processing result exceeding the threshold, check whether a back search window before a highest peak in the first receive signal comprises a peak and discard the first processing result in reaction to the back search window before the highest peak in the first receive signal comprising a peak and check whether a back search window before a highest peak in the second receive signal comprises a peak and discard the second processing result in reaction to the back search window before the highest peak in the second receive signal comprising a peak.

Example 5 is the ranging device of example 3 or 4, wherein the processor is configured to discard that one of the first processing result and the second processing result which is less close to a processing result the processor has generated from earlier pulses of a sequence of earlier pulses sent by the transmitter earlier than the sequence of first pulses and the sequence of second pulses.

Example 6 is the ranging device of example 5, wherein the processor is configured to determine the range between the transmitter and the ranging device from that one of the first processing result and the second processing result which is closer to the processing result the processor has generated from the earlier pulses of the sequence of earlier pulses sent by the transmitter earlier than the sequence of first pulses and the sequence of second pulses.

Example 7 is the ranging device of any one of examples 2 to 6, wherein the processor is configured to determine the range between the transmitter and the ranging device from one or more processing results generated from analyzing a timing of one or more peaks in a further receive signal received by the receiver in the reception of further pulses of one or more sequences of further pulses other than the sequence of first pulses and the sequence of second pulses in reaction to the difference of the first processing result and the second processing result exceeding the threshold.

Example 8 is the ranging device of any one of examples 1 to 7, wherein the first radar processing result is a first estimate of the distance between the transmitter and the ranging device and the second radar processing result is a second estimate of the distance between the transmitter and the ranging device.

Example 9 is the ranging device of any one of examples 1 to 3 or 5 to 7, wherein the first processing result is a first time distance between an earliest peak in a back search window before the highest peak in the first receive signal and the second processing result is a second time distance between an earliest peak in a back search window before a highest peak in the second receive signal.

Example 10 is the ranging device of examples 2 and 9, wherein the processor is configured to determine the range between the transmitter and the ranging device from the earliest peak in the back search window before the highest peak in the first receive signal and/or from the earliest peak in the back search window before the highest peak in the second receive signal in reaction to the difference between the first time distance and the second time distance not exceeding the threshold.

Example 11 is a method for performing radar range estimation between a transmitter and a receiver, comprising receiving first pulses of a sequence of first pulses sent by a transmitter with a first interval between pulses at the receiver, receiving second pulses of a sequence of pulses second sent by the transmitter with a second interval between pulses at the receiver, wherein the first interval is different from the second interval, and generating a first processing result by analyzing a timing of one or more peaks in a first receive signal received by the receiver in the reception of the first pulses, generating a second processing result by analyzing a timing of one or more peaks in a second receive signal received by the receiver in the reception of the second pulses and determining a range between the transmitter and the ranging device depending on a result of a comparison of the first processing result and the second processing result.

Examples described in the context of the ranging device are analogously valid for the method.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A ranging device, comprising:
a receiver configured to:
receive first pulses of a sequence of first pulses sent by a transmitter with a first interval between pulses and
receive second pulses of a sequence of pulses second sent by the transmitter with a second interval between pulses, wherein the first interval is different from the second interval; and
a processor configured to
generate a first processing result by analyzing a timing of one or more peaks in a first receive signal received by the receiver in the reception of the first pulses;
generate a second processing result by analyzing a timing of one or more peaks in a second receive signal received by the receiver in the reception of the second pulses; and
determine a range between the transmitter and the ranging device depending on a result of a comparison of the first processing result and the second processing result.

2. The ranging device of claim 1, wherein the processor is configured to perform the comparison of the first processing result and the second processing result by comparing a difference of the first processing result and the second processing result with a threshold.

3. The ranging device of claim 2, wherein the processor is configured to discard the first processing result and/or the second processing result in reaction to the difference of the first processing result and the second processing result exceeding the threshold.

4. The ranging device of claim 3, wherein the processor is configured to, in reaction to the difference of the first processing result and the second processing result exceeding the threshold, check whether a back search window before a highest peak in the first receive signal comprises a peak and discard the first processing result in reaction to the back search window before the highest peak in the first receive signal comprising a peak and check whether a back search window before a highest peak in the second receive signal comprises a peak and discard the second processing result in reaction to the back search window before the highest peak in the second receive signal comprising a peak.

5. The ranging device of claim 4, wherein the processor is configured to discard that one of the first processing result and the second processing result which is less close to a processing result the processor has generated from earlier pulses of a sequence of earlier pulses sent by the transmitter earlier than the sequence of first pulses and the sequence of second pulses.

6. The ranging device of claim 5, wherein the processor is configured to determine the range between the transmitter and the ranging device from that one of the first processing result and the second processing result which is closer to the processing result the processor has generated from the earlier pulses of the sequence of earlier pulses sent by the transmitter earlier than the sequence of first pulses and the sequence of second pulses.

7. The ranging device of claim 1, wherein the processor is configured to determine the range between the transmitter and the ranging device from one or more processing results generated from analyzing a timing of one or more peaks in a further receive signal received by the receiver in the reception of further pulses of one or more sequences of further pulses other than the sequence of first pulses and the sequence of second pulses in reaction to the difference of the first processing result and the second processing result exceeding the threshold.

8. The ranging device of claim 1, wherein the first processing result is a first estimate of the distance between the transmitter and the ranging device and the second processing result is a second estimate of the distance between the transmitter and the ranging device.

9. The ranging device of claim 1, wherein the first processing result is a first time distance between an earliest peak in a back search window before a highest peak in the first receive signal and the second processing result is a second time distance between an earliest peak in a back search window before a highest peak in the second receive signal.

10. The ranging device of claim 1, wherein the processor is configured to determine the range between the transmitter and the ranging device from an earliest peak in the back search window before a highest peak in the first receive signal and/or from an earliest peak in a back search window before a highest peak in the second receive signal in reaction to a difference between the first time distance and the second time distance not exceeding the threshold.

11. A method for performing range estimation between a transmitter and a receiver, comprising:
receiving first pulses of a sequence of first pulses sent by a transmitter with a first interval between pulses at the receiver;
receiving second pulses of a sequence of pulses second sent by the transmitter with a second interval between pulses at the receiver, wherein the first interval is different from the second interval; and
generating a first processing result by analyzing a timing of one or more peaks in a first receive signal received by the receiver in the reception of the first pulses;
generating a second processing result by analyzing a timing of one or more peaks in a second receive signal received by the receiver in the reception of the second pulses; and
determining a range between the transmitter and the ranging device depending on a result of a comparison of the first processing result and the second processing result.

12. The method of claim 11, further comprising comparing a difference of the first processing result and the second processing result with a threshold.

13. The method of claim 12, further comprising discarding the first processing result and/or the second processing result in reaction to the difference of the first processing result and the second processing result exceeding the threshold.

14. The method of claim 13, further comprising: in reaction to the difference of the first processing result and the second processing result exceeding the threshold:
checking whether a back search window before a highest peak in the first receive signal comprises a peak and discard the first processing result in reaction to the back search window before the highest peak in the first receive signal comprising a peak; and
checking whether a back search window before a highest peak in the second receive signal comprises a peak and discard the second processing result in reaction to the back search window before the highest peak in the second receive signal comprising a peak.

15. The method of claim 14, further comprising discarding the one of the first processing result and the second processing result which is less close to a processing result the processor has generated from earlier pulses of a sequence of earlier pulses sent by the transmitter earlier than the sequence of first pulses and the sequence of second pulses.

16. The method of claim 15, further comprising determining the range between the transmitter and the ranging device from that one of the first processing result and the second processing result which is closer to the processing result the processor has generated from the earlier pulses of the sequence of earlier pulses sent by the transmitter earlier than the sequence of first pulses and the sequence of second pulses.

17. The method of claim 11, further comprising determining the range between the transmitter and the ranging device from one or more processing results generated from analyzing a timing of one or more peaks in a further receive signal received by the receiver in the reception of further pulses of one or more sequences of further pulses other than the sequence of first pulses and the sequence of second pulses in reaction to the difference of the first processing result and the second processing result exceeding the threshold.

18. The method of claim 11, wherein the first processing result is a first estimate of the distance between the transmitter and the ranging device and the second processing result is a second estimate of the distance between the transmitter and the ranging device.

19. The method of claim 11, wherein the first processing result is a first time distance between an earliest peak in a back search window before a highest peak in the first receive signal and the second processing result is a second time distance between an earliest peak in a back search window before a highest peak in the second receive signal.

20. The method of claim 11, further comprising determining the range between the transmitter and the ranging device from an earliest peak in the back search window before a highest peak in the first receive signal and/or from an earliest peak in a back search window before a highest peak in the second receive signal in reaction to a difference between the first time distance and the second time distance not exceeding the threshold.
